(19) United States
(12) Patent Application Publication
(10) Pub. No.: US 2016/0163145 A1
(43) Pub. Date: Jun. 9, 2016

(54) PAPER SHEET TRANSACTION DEVICE

(71) Applicant: FUJITSU FRONTECH LIMITED, Tokyo (JP)

(72) Inventor: Tomoyuki Tamahashi, Inagi (JP)

(21) Appl. No.: 15/046,719

(22) Filed: Feb. 18, 2016

Related U.S. Application Data
(63) Continuation of application No. PCT/JP2013/073068, filed on Aug. 28, 2013.

(51) Int. Cl. G07D 11/00

(52) U.S. Cl. CPC G07D 11/0033; G07D 11/0006; G07D 11/0045

(57) ABSTRACT

A paper sheet transaction device includes a drop unit, a storage unit, a temporary holder, and a control unit, wherein the temporary holder is removably provided in the paper sheet transaction device, and the control unit performs a control such that the temporary holder is a space that temporarily holds a paper sheet dropped through the drop unit before the paper sheet is stored in the storage unit, performs a control such that the temporary holder is a space into which at least a portion of the paper sheets in the storage unit is collected, and performs a control such that the paper sheets stored in advance in the temporary holder are transported to the storage unit.

### CROSS-REFERENCE TO RELATED APPLICATIONS

This application is a continuation application of International PCT Application No. PCT/JP2013/073068 which was filed on Aug. 28, 2013.

### BACKGROUND OF THE INVENTION

1. Field of the Invention

The present invention relates to control processing on a temporary holder in a paper sheet transaction device.

2. Description of the Related Art

In financial institutions, there are cash transaction devices that are paper sheet transaction devices. As cash transaction devices, an ATM (automatic teller machine) that is manipulated by a customer himself/herself and/or a teller machine (or also referred to as “cashier machine”) that is exclusively manipulated by a bank employee are installed. The teller machine is installed under a teller counter of a bank employee, and, for example, a withdrawal/deposit or a bankbook update is performed by use of the ATM or the teller machine.

Inside the cash transaction device, a storage container (also referred to as a “cassette”) that stores therein cash such as bills and coins is provided for each denomination of, for example, a bill. The cash transaction device has a cashbox structure as part of itself, and the storage containers are provided inside the cashbox structure by which the storage containers are protected. The door of the cashbox is naturally locked. Patent Document 1 discloses an example of a cashbox of an automatic transaction device.

For the purpose of enhancing security, there is a case in which an operation is performed such that a person in charge of a branch of a bank is not allowed to unlock a cashbox, and only a person in charge of a management company (a security company) of cash management and transportation that is collaborated with the financial institution is allowed to unlock cashbox.

### PATENT DOCUMENT

Patent Document 1: Japanese Laid-open Patent Publication No. 2005-196607

### SUMMARY OF THE INVENTION

In order to attain the above object, a paper sheet transaction device used for a paper sheet transaction performed by a user includes a drop unit through which a paper sheet is dropped, a storage unit that stores therein a paper sheet dropped through the drop unit, a temporary holder that temporarily stores therein a predetermined number of paper sheets, and a control unit that controls transportation of the paper sheets between the drop unit and the storage unit according to a content of processing, wherein the temporary holder is removably provided in the paper sheet transaction device, and the control unit performs a control such that the temporary holder is a space that temporarily holds a paper sheet dropped through the drop unit before the paper sheet is stored in the storage unit when processing of a paper sheet transaction performed by the user is performed, performs a control such that the temporary holder is a space into which at least a portion of the paper sheets in the storage unit are collected when processing of collecting the paper sheets from the storage unit is performed, and performs a control such that the paper sheets stored in advance in the temporary holder are transported to the storage unit when processing of replenishing the storage unit with the paper sheets is performed.

### BRIEF DESCRIPTION OF THE DRAWINGS

FIG. 1 is a diagram that illustrates a system as a whole to which ATMs 100 and teller machines 200 are connected;

FIG. 2 is a block diagram that illustrates a main configuration inside the ATM 100 and the teller machine 200;

FIG. 3 is a diagram that illustrates the inside of the ATM 100 and that explains a transportation route;

FIG. 4 is a schematic diagram that illustrates a temporary holder 140 and the vicinity of the connection between the temporary holder 140 and the ATM 100;

FIG. 5 is a diagram that illustrates a route on which a dropped bill is transported to the temporary holder 140 in the ATM 100;

FIG. 6 is a diagram that illustrates a route on which the bill is transported from the temporary holder 140 to a storage unit 152 in the ATM 100;

FIG. 7 is a diagram that illustrates a route on which a dropped bill is excluded in the ATM 100;

FIG. 8 is a diagram that illustrates a route on which a bill is transported from the temporary holder 140 to a reject unit 154 in the ATM 100;

FIG. 9 is a diagram that illustrates a route on which a bill is transported from the storage unit 152 to a drop and discharge unit 132 in the ATM 100;

FIG. 10 is a diagram that illustrates a processing route for replenishing the storage unit 152 with bills from the temporary holder 140 in the ATM 100;

FIG. 11 is a diagram that illustrates a processing route for collecting bills into the temporary holder 140 from the storage unit 152 in the ATM 100;

FIG. 12 is a diagram that illustrates the inside of the teller machine 200 and that explains a transportation route;

FIG. 13 is a diagram that illustrates a route on which a dropped bill is transported to a storage unit 252 via the temporary holder 140 in the teller machine 200;

FIG. 14 is a diagram that illustrates a processing route for replenishing the storage unit 252 with bills from the temporary holder 140 in the teller machine 200;

FIG. 15 is a diagram that illustrates a processing route for collecting bills into the temporary holder 140 from the storage unit 252 in the teller machine 200;

FIG. 16 is a flowchart that illustrates a procedure of processing of stopping a cash transaction device until a person in charge of a management company visits to replenish with bills when there is a shortage of bills in the ATM 100;

FIG. 17 is a flowchart that illustrates processing of stopping a cash transaction device until a person in charge of a management company visits to collect bills when the ATM 100 is full of bills;

FIG. 18 is a flowchart that illustrates a procedure of processing of replenishing the storage unit 152 with bills from the temporary holder 140 when there is a shortage of bills in the ATM 100; and

FIG. 19 is a flowchart that illustrates a procedure of processing of collecting bills from the storage unit 152 to the temporary holder 140 when the ATM 100 is full of bills.

### DETAILED DESCRIPTION OF THE PREFERRED EMBODIMENTS

Embodiments of the present invention will now be described with reference to the drawings. In the following description, an ATM (automatic teller machine) and a teller machine (or also referred to as “cashier”) are also collectively referred to as a paper sheet transaction device or a cash transaction device. Both the ATM and the teller machine are connected to a host computer and have a function that automatically performs various transactions such as a cash (paper sheet) deposit/withdrawal, a bankbook update, and a money transfer. In other words, the ATM and the teller machine are substantially the same except that a customer is an exclusive user of the ATM and a bank employee is an exclusive user of the teller machine. In this example, bills are used for explanation, but the embodiments are not limited thereto. Like bills, securities are also included in the paper sheets.

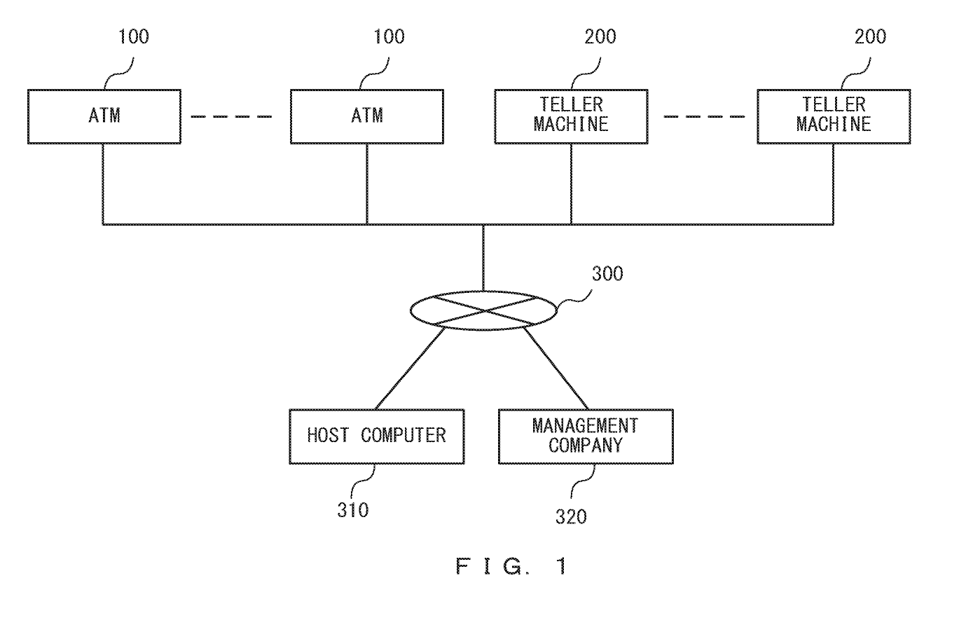

FIG. 1 is a diagram that illustrates a system as a whole to which ATMs 100 and teller machines 200 installed in branches of financial institutions are connected. An ATM 100 and a teller machine 200 are connected, via a network 300, to a host computer 310 and to a management company 320 that takes care of cash transportation and management.

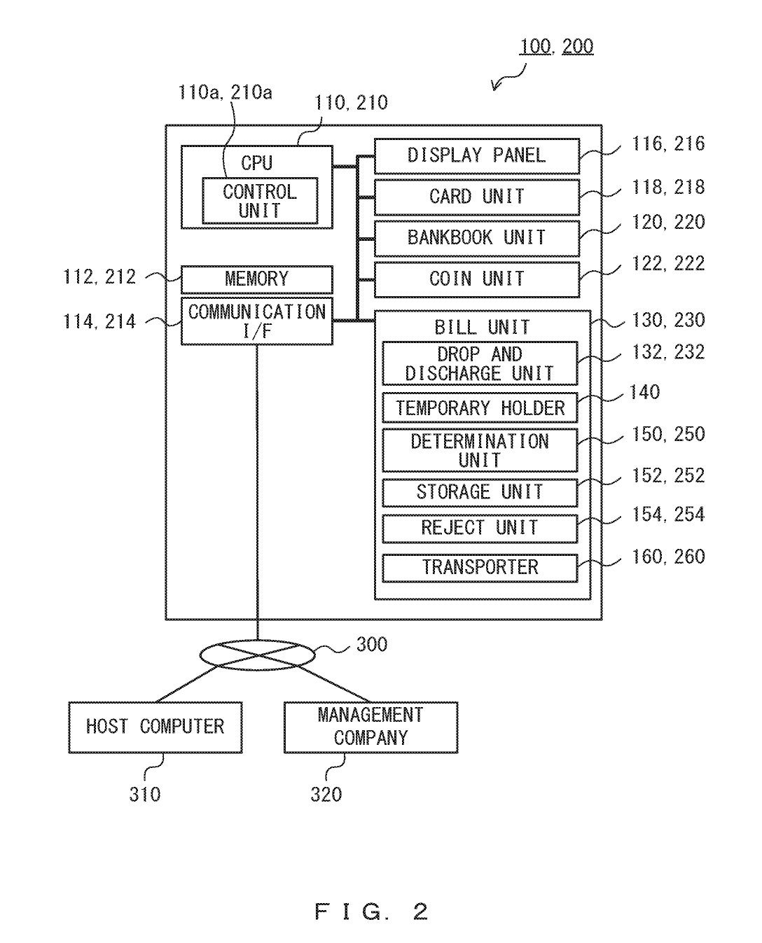

FIG. 2 is a block diagram that illustrates a main configuration inside the ATM 100 and the teller machine 200. The ATM 100 and the teller machine 200 have common basic functions and have substantially the same inside configuration, so their block diagrams are identical to each other. The block diagram of the ATM 100 will be described, and that of the teller machine 200 is the same unless otherwise specified. Series 100 numbers refer to elements of the ATM 100, series 200 numbers refer to elements of the teller machine 200. A “customer” in a description of the ATM 100 corresponds to a “bank employee” for the teller machine 200.

The ATM 100 (the teller machine 200, the series 200 numbers in parentheses below are for the teller machine 200) has a CPU 110 (210), a memory 112 (212), a communication I/F 114 (214), a display panel 116 (216), a card unit 118 (218), a bankbook unit 120 (220), a coin unit 122 (222), and a bill unit 130 (230). The CPU 110 reads a program so as to perform an overall control on the entirety of the ATM 100. A control function executed by the CPU 110 is illustrated as a control unit 110a (210a).

The memory 112 is provided with a memory for temporary storage and a memory for archival storage. The memory for temporary storage is, for example, a RAM and is a working area in which data or a program is temporality stored. The memory for archival storage is a flash memory or a hard disk drive, in which, for example, a processing program read by the CPU 110 or archival data is stored. Further, the memory for archival storage stores therein, as data on the number of bills, the number of bills for each denomination that are stored inside the ATM 100.

The communication I/F 114 performs, via the network 300, communication of various pieces of data between the ATM 100 and, for example, the host computer 310 or the management company 320. The host computer 310 is installed in a bank host center. For example, a withdrawal requesting telegraphic message corresponding to an input of a customer is transmitted from the ATM 100 to the host computer 310, and correspondingly, for example, a withdrawal approving telegraphic message is transmitted from the host computer 310 to the ATM 100. Further, the operating conditions of the ATM 100, and the quantity and the state of coins or bills stored inside the ATM 100 are transmitted to a computer of the management company 320.

The display panel 116 has a display unit and a manipulation unit. The display unit is, for example, an LCD, and displays, for example, a manipulation guidance for customers, a transaction menu, or a numeric keypad for input, on the basis of an instruction issued by the control unit 110a. The manipulation unit is a touch panel integral with the display unit, and detects an input from a customer. The manipulation unit reports the detected input data to the control unit 110a. The manipulation unit may be a keyboard instead of a touch panel.

The card unit 118 transports, inside itself, a bank card inserted by a customer into the ATM 100, writes information to or reads information from, for example, a magnetic stripe, and discharges the card outside to return after the processing. When the bank card is an IC card, writing and reading are performed on an IC chip.

The bankbook unit 120 transports, inside itself, a bankbook inserted by a customer into the ATM 100, writes information to or reads information from, for example, a magnetic stripe attached to the front cover of the bankbook, and discharges the bankbook outside to return after the processing. Further, the bankbook unit 120 prints transaction history information on the bankbook.

The coin unit 122 includes a coin cassette (not shown) that stores therein coins, and takes out a predetermined number of coins from the coin cassette according to an instruction to perform a payment transaction and discharges them through a coin discharge slot (not shown).

The bill unit 130 takes out a predetermined number of bills from the storage unit and discharges them, and stores deposited bills in the storage unit. The bill unit 130 has a drop and discharge unit 132 (232), a temporary holder 140, a determination unit 150 (250), a storage unit 152 (252), a reject unit 154 (254), and a transporter 160 (260). The ATM 100 and the teller machine 200 have the same temporary holder 140 that is referred to by the same reference number. The details will be described below.

The drop and discharge unit 132 serves as a drop slot through which a customer drops a bill and also serves as a discharge slot through which a bill transported from the inside is given to a customer. The drop and discharge unit 132 is protected by a door except when a bill is dropped or discharged. Further, the drop and discharge unit 132 is provided with a bill detection sensor (not shown) that detects whether there is a bill, and a detection result is reported to the control unit 110a.

The temporary holder 140 is a space that temporarily stores therein bills dropped by a customer through the drop and discharge unit 132. It is also referred to as “escrow”. The reason is that a counted amount of money dropped is displayed on the display panel 116 immediately after the bills are dropped, and the bills dropped by the customer have to be stored until an instruction that approves the displayed amount is issued by the customer. This is for the purpose of avoiding any trouble with a customer. The temporary holder 140 is able to store therein, for example, about two hundred bills together.

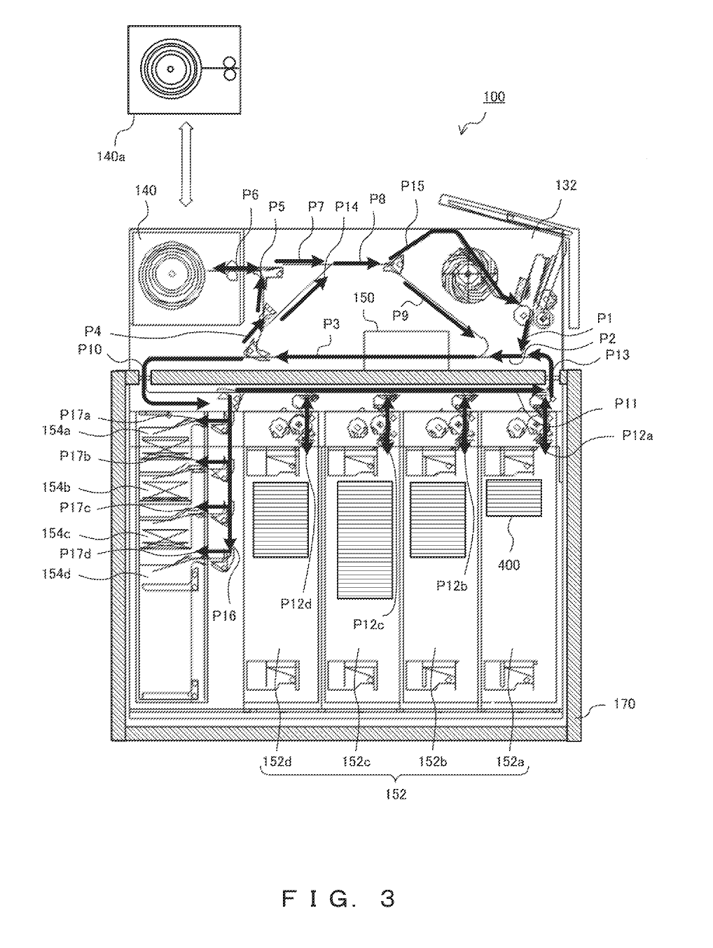

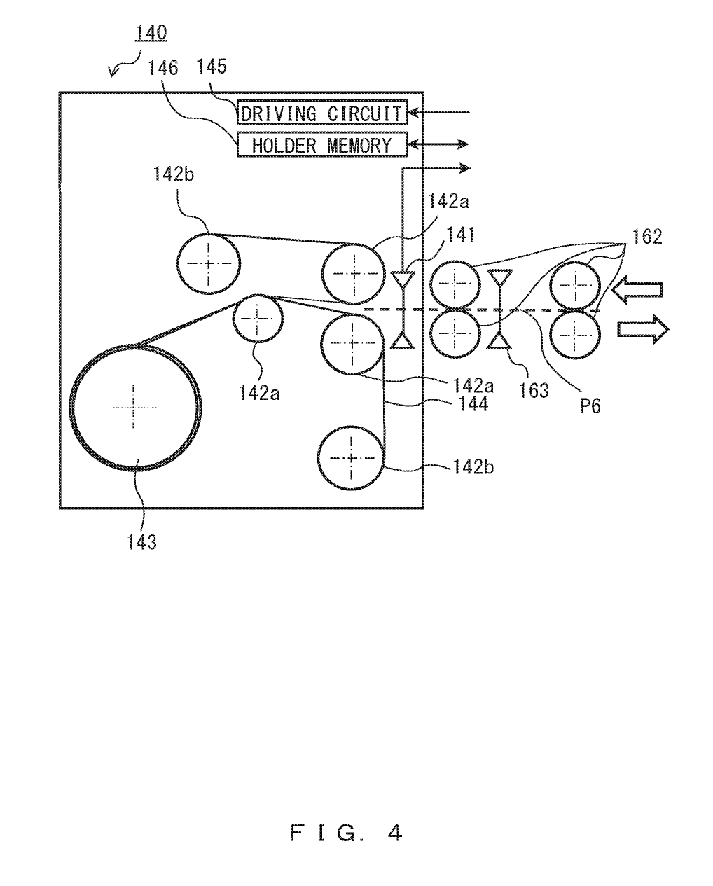

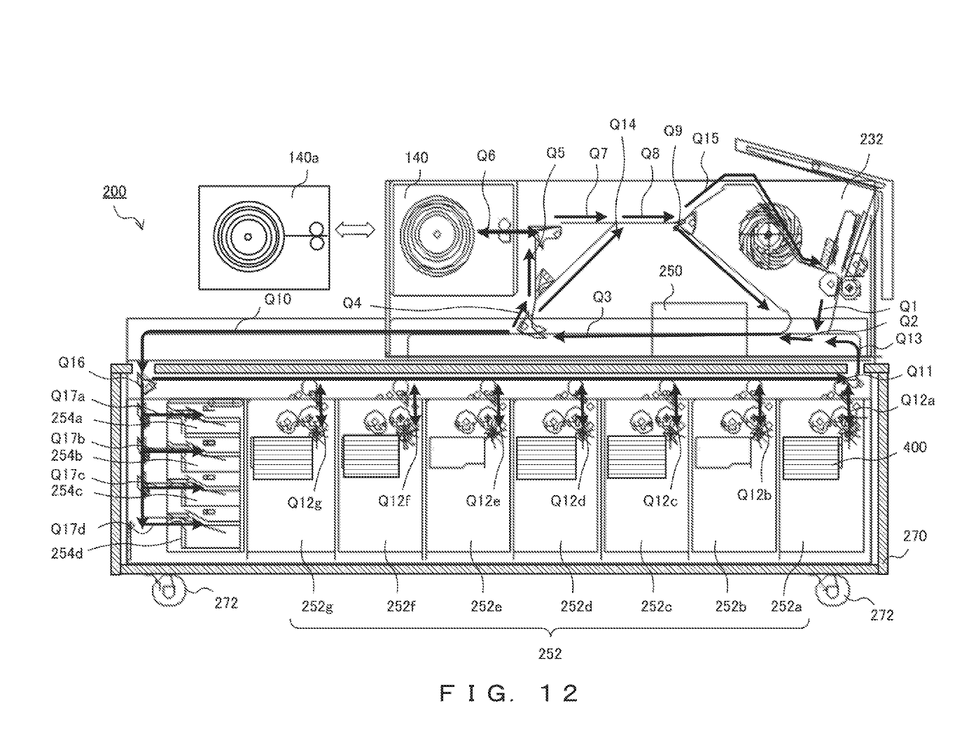

The temporary holder 140 is removably mounted in the ATM 100, and further, it is removable with respect to both the ATM 100 and the teller machine 200. It will be described in detail in FIG. 3 and FIG. 12. The inside of the temporary holder 140 will be described in detail in FIG. 4.

Moreover, the temporary holder 140 is also used for storing therein bills transported and collected from the storage unit 152 (bill collection processing) when the storage unit 152 is full or nearly full of bills, and for storing therein bills with which the storage unit 152 is to be replenished when there is a shortage of bills in the storage unit 152 (bill replenishment processing).

The determination unit 150 determines the authenticity of a bill and whether a bill is recyclable (reusable). Determination is performed by the determination unit 150 on a bill dropped through the drop and discharge unit 132 before the bill enters the temporary holder 140. A result of the determination performed by the determination unit 150 is reported to the control unit 110a. Upon withdrawal, a bill to be discharged from the storage unit 152 to a customer is also discharged after determination is performed by the determination unit 150 on the bill. A damaged bill such as a torn one is determined by the determination unit 150 to be non-recyclable and is transported to the reject unit 154.

The storage unit 152 stores therein dropped bills or bills to be discharged (to be withdrawn) for each denomination. The storage unit 152 is constituted of a plurality of bill cassettes for different denominations of a bill. Each of the bill cassettes in the storage unit 152 is provided with a “full”-detection sensor (not shown) that detects a state in which the cassette is full of (filled with) bills or a “nearly full”-detection sensor (not shown) that detects a state in which the cassette is nearly full of bills. Further, the number of bills for each denomination that are stored in the storage unit 152 is managed by the control unit 110a as data on the number of bills in the memory 112.

The reject unit 154 stores therein a damaged bill that is non-recyclable (non-reusable). The reject unit 154 has a reject cassette for each denomination, and stores therein a bill determined by the determination unit 150 to be non-recyclable (non-reusable).

The transporter 160 transports a bill between the drop and discharge unit 132 and the storage unit 152 or the reject unit 154 via a route according to a content of processing. The transporter 160 has, for example, transportation paths for transporting a bill, driving rollers that sandwich a bill between themselves and transport the bill, and a driving motor that rotates the driving rollers. A selection of a transportation path and a rotation of the driving motor are controlled by the control unit 110a according to a content of manipulation performed by a customer or according to a result of determination performed by the determination unit 150. Further, each of the transportation paths is provided, in various positions, with sensors (not shown) that detect the passage of a bill and report it to the control unit 110a.

The management company 320 regularly sends a person in charge to a branch of a bank so that there is no shortage of bills in a cash transaction device (the ATM 100 or the teller machine 200) or so that a cassette is not full of bills. Further, when a shortage of bills or the occurrence of a “full” state is detected in the ATM 100 or the teller machine 200, necessary information is transmitted by the control unit 110a through the communication I/F 114. The transmitted information is reported to the management company 320 through the network 300.

When receiving a report about a shortage of bills from the ATM 100 or the teller machine 200, the management company 320 also sends the person in charge to the site. The person in charge opens a cashbox in the cash transaction device that will be described below, and replenishes the storage unit 152 with bills or collects bills from the storage unit 152.

[Bill Transportation Route in ATM 100]

FIG. 3 is a diagram that illustrates the inside of the ATM 100 and that explains the entirety of a transportation route. FIGS. 4 to 9 are diagrams that explain the bill transportation route during a transaction performed by a user (a customer) in the ATM 100.

In FIG. 3, the location in which a customer performs manipulation is on the right. The ATM 100 is provided with the drop and discharge unit 132 on its upper right and the temporary holder 140 on its upper left. The temporary holder 140 is fixed to the ATM 100 with, for example, a screw, a locking lever, or a latch so as to be removable from the ATM 100. The determination unit 150 is provided in the center of the ATM 100. A temporary holder 140a on the upper left of FIG. 3 represents an unmounted state.

The ATM 100 is provided with the storage unit 152 in its lower part. The storage unit 152 includes four vertically long bill cassettes (152a, 152b, 152c, and 152d) for different denominations that are arranged in parallel from the right. Bills 400 are loaded in each bill cassette in the storage unit 152. The ATM 100 is provided with the reject unit 154 on its lower left. Four reject cassettes (154a, 154b, 154c, and 154d) are arranged in the reject unit 154 in order from the top.

The ATM 100 is provided with a cashbox 170 in its lower section. The storage unit 152 and the reject unit 154 are provided inside the cashbox 170. The cashbox 170 is locked by use of a door with a key (not shown) so as to protect the insides of the storage unit 152 and the reject unit 154. In other words, only a person who has a key of the cashbox 170 is able to directly supply the storage unit 152 with bills and to collect bills directly from the storage unit 152. On the other hand, the temporary holder 140 is arranged outside the cashbox 170, so it can be removed without the key of the cashbox 170.

The entirety of a transportation route will be described. Transportation path P1 proceeding diagonally down and to the left and then transportation path P2 proceeding to the left are provided so as to transport, to the inside, a bill dropped through the drop and discharge unit 132. Transportation path P3 proceeding to the left passing through the determination unit 150 is provided and distally divided into two paths, and transportation path P4 proceeding diagonally up and to the right and transportation path P10 proceeding straight to the left are provided. Transportation path P4 is distally divided into two paths, and transportation path P5 proceeding straight up and transportation path P14 proceeding diagonally up and to the right are provided.

Transportation path P5 is distally divided into two paths, and transportation path P6 proceeding to the right and left and transportation path P7 proceeding to the right are provided. Proceeding to the left in transportation path P6 leads into the temporary holder 140. Transportation path P8 proceeding to the right is provided so as to be continuous from transportation path P7. Transportation path P8 is distally divided into two paths, and transportation path P9 proceeding diagonally down and to the right and transportation path P15 proceeding diagonally up and to the right are provided.

Transportation path P10 proceeding to the left enters the cashbox 170 and is divided into two paths, and transportation path P11 proceeding to the right and transportation path P16 proceeding straight down are provided. Transportation path P11 is provided to the right along the top of each bill cassette in the storage unit 152.

Transportation path P12d that corresponds to the bill cassette 152d is provided so as to proceed downward midway in transportation path P11. Likewise, transportation path P12c that corresponds to the bill cassette 152c, transportation path P12b that corresponds to the bill cassette 152b, and transportation path P12a that corresponds to the bill cassette 152a are provided in different positions in transportation path P11, respectively.

Transportation path P13 proceeding straight up and then turns to the left is provided at the distal end of transportation path P11. Transportation path P13 proceeds out of the cashbox 170. The distal end of transportation path P13 is connected to the back end of transportation path P2.

The proceeding-down transportation path P16 is provided along the right side of the four reject cassettes in the reject unit 154. From transportation path P16, transportation path P17a that corresponds to the reject cassette 154a is provided. Likewise, from transportation path P16, transportation path P12b that corresponds to the reject cassette 154b, transportation path P17c that corresponds to the reject cassette 154c, and transportation path P17d that corresponds to the reject cassette 154d are provided, respectively.

FIG. 4 is a schematic diagram that illustrates a transportation structure of the temporary holder 140 in the vicinity of the connection between the temporary holder 140 and the ATM 100. Rollers 162 that transport a bill and a sensor 163 that detects the passage of a bill are appropriately arranged in transportation path P6 of the ATM 100.

The temporary holder 140 has a sensor 141, rollers 142a, take-up-film rollers 142b, a bill-take-up roller 143, and a film 144. The sensor 141 detects the passage of a bill. The film 144 sandwiches a bill to take it up. Both ends of the film 144 are mounted on the take-up-film rollers 142b. A bill transported from the rollers 162 is sandwiched between the two films 144 and taken up by the bill-take-up roller 143.

Further, the temporary holder 140 has a driving circuit 145 for driving, for example, the take-up-film rollers 142b, and a holder memory 146 for storing therein the number of bills stored in the temporary holder 140. The number of bills stored in the temporary holder 140 is recorded by the control unit 110a in the holder memory 146. If the number of bills stored in the temporary holder 140 is recorded, the number of bills stored in the temporary holder 140 is immediately obtained by reading, in the teller machine 200, data on the number of bills in the holder memory 146, for example, when the temporary holder 140 is mounted in the teller machine 200 from the ATM 100. Moreover, ID numbers may be respectively allocated to a plurality of temporary holders 140, and the holder memory 146 may store therein an ID number of a corresponding temporary holder 140.

Furthermore, the sensor 141, the driving circuit 145, and the holder memory 146 of the temporary holder 140 are electrically connected to, for example, the control unit 110ain the body of the ATM 100 through, for example, a connector (not shown). The removal of the temporary holder 140 is detected by the control unit 110a, and the number of bills stored in the temporary holder 140 is managed by the control unit 110a. Further, when an ID number is allocated to the temporary holder 140, the control unit 110a stores therein the ID number as well as the date and time of mounting with respect to the mounted temporary holder 140, and manages them.

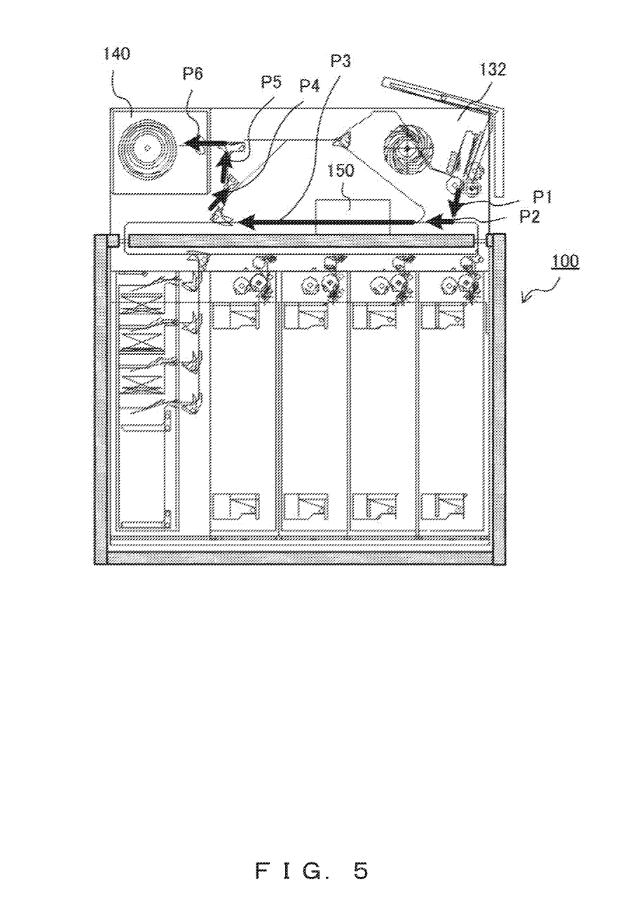

FIG. 5 is a diagram that illustrates a route on which a dropped bill is transported to the temporary holder 140 in the ATM 100. A bill dropped by a customer through the drop and discharge unit 132 enters the determination unit 150 via “transportation path P1→transportation path P2→transportation path P3”. The bill that is allowed by the determination unit 150 as a determination result is stored in the temporary holder 140 via “transportation path P3→transportation path P4→transportation path P5→transportation path P6”. In a state in which the bill is stored in the temporary holder 140, a deposit amount is displayed by the control unit 110a on the display panel 116, and the bill waits for approval manipulation performed by the customer.

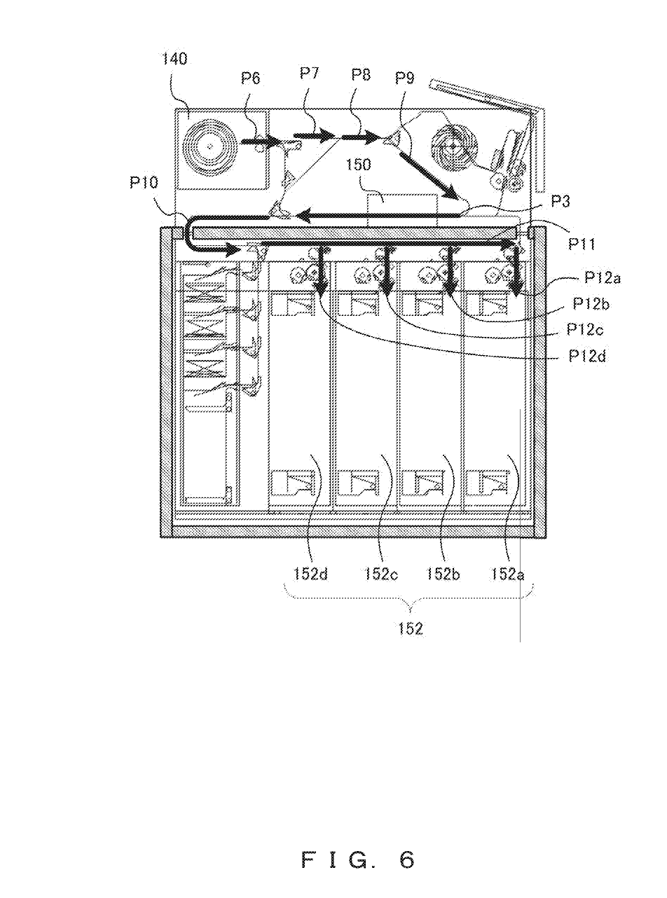

FIG. 6 is a diagram that illustrates a route on which the bill is transported from the temporary holder 140 to the storage unit 152 in the ATM 100. When it detects the approval manipulation performed by the customer, the control unit 110a transports the bill stored in the temporary holder 140 to the storage unit 152.

The bill is transported from the temporary holder 140 via “transportation path P6→transportation path P7→transportation path P8→transportation path P9→transportation path P3→transportation path P10→transportation path P11” and is stored in one of the bill cassettes (152a, 152b, 152c, or 152d) in the storage unit 152 via a transportation path (transportation path P12a, transportation path P12b, transportation path P12c, or transportation path P12d) according to a denomination.

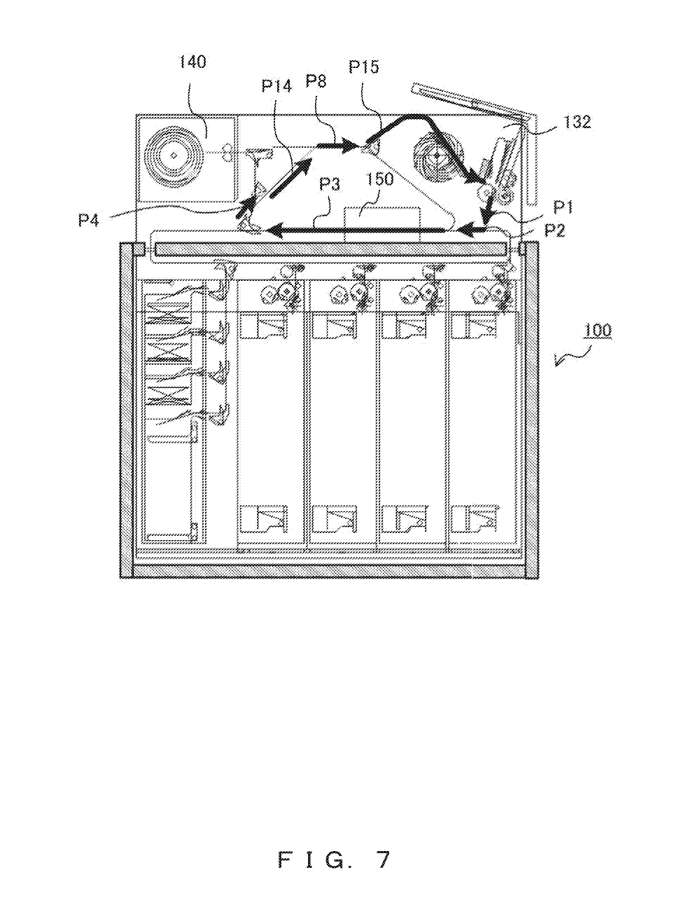

FIG. 7 is a diagram that illustrates a route on which a dropped bill is excluded in the ATM 100. When a dropped bill is not a normal bill (for example, a bill of a foreign country), the bill is returned to a customer. The bill dropped by the customer through the drop and discharge unit 132 enters the determination unit 150 via “transportation path P1→transportation path P2→transportation path P3”. When reporting, to the control unit 110a, a determination result obtained by the determination unit 150 that the bill is not a normal bill, the bill is returned to the drop and discharge unit 132 via “transportation path P3→transportation path P4→transportation path P14→transportation path P8→transportation path P15” without being stored in the temporary holder 140.

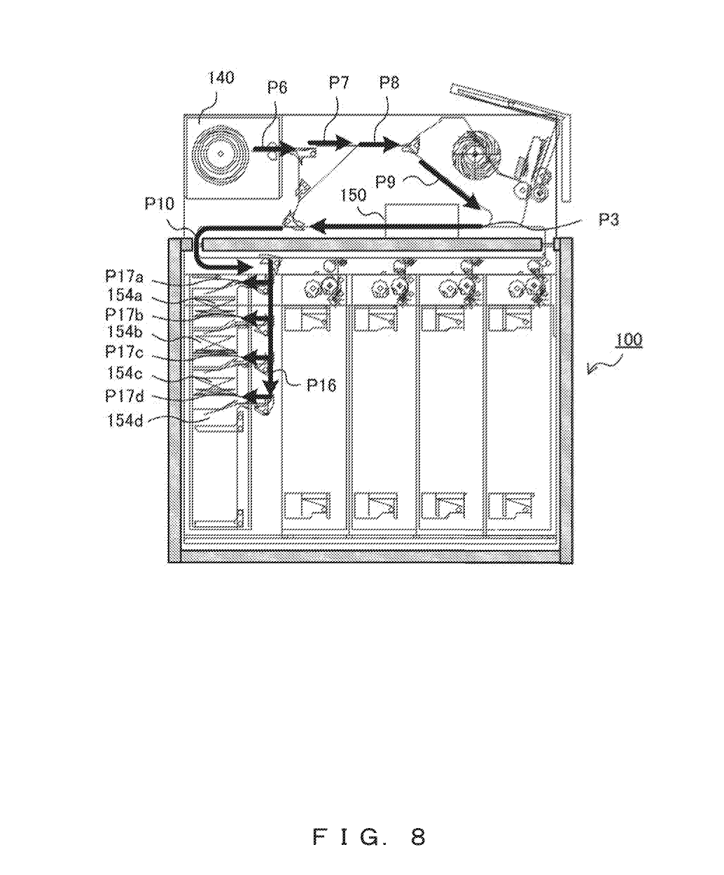

FIG. 8 is a diagram that illustrates a route on which a bill is transported from the temporary holder 140 to the reject unit 154 in the ATM 100. A bill that has been determined by the determination unit 150 to be unsuitable for recycling (reuse) is stored in the reject unit 154. The bill enters the determination unit 150 from the temporary holder 140 via “transportation path P6→transportation path P7→transportation path P8→transportation path P9→transportation path P3”.

When reporting, to the control unit 110a, a determination result obtained by the determination unit 150 that the bill is unsuitable for recycling, the bill is transported by the control unit 110a via “transportation path P10→transportation path P16” and stored in one of the four reject cassettes in the reject unit 154 via one of the transportation paths (transportation path P17a, transportation path P17b, transportation path P17c, or transportation path P17d) according to a denomination.

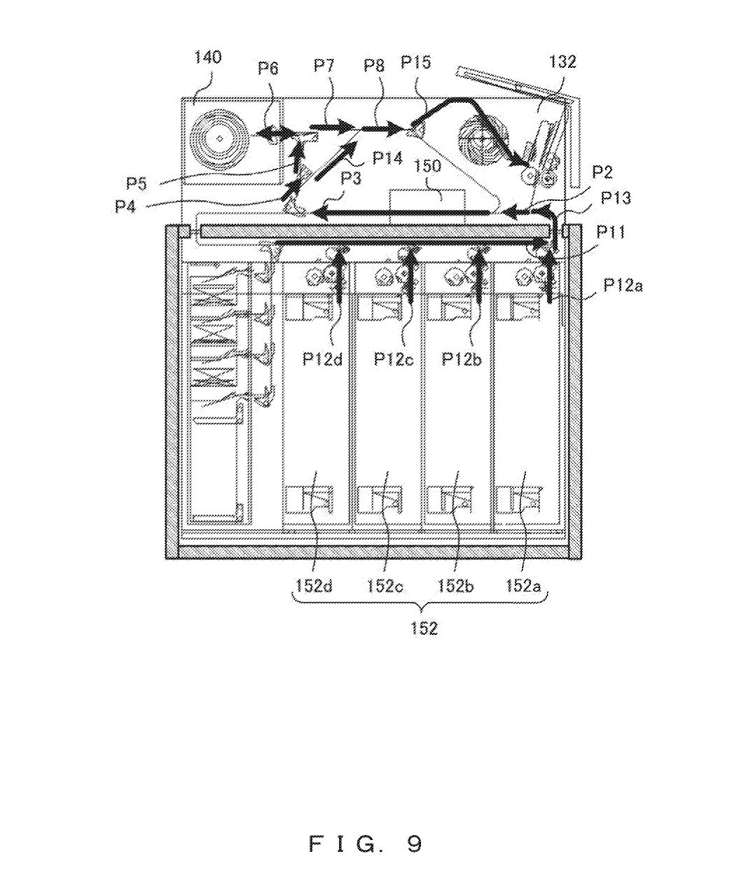

FIG. 9 is a diagram that illustrates a route on which a bill is transported from the storage unit 152 to the drop and discharge unit 132 in the ATM 100. For example, this is a case in which a bill is discharged by withdrawal manipulation performed by a customer. A bill is taken out from a bill cassette (152a, 152b, 152c, or 152d) via a transportation path (transportation path P12a, transportation path P12b, transportation path P12c, or transportation path P12d) according to a denomination. The bill is transported via “transportation path P11→transportation path P13→transportation path P2→transportation path P3→transportation path P4”. When the bill is first stored in the temporary holder 140 from transportation path P4, the bill moves via “transportation path P5→transportation path P6”. The bill stored in the temporary holder 140 is transported to the drop and discharge unit 132 moving via “transportation path P6→transportation path P7→transportation path P8→transportation path P15”. Further, when the bill is directly transported from transportation path P4 to the drop and discharge unit 132, the bill is transported to the drop and discharge unit 132 moving via “transportation path P14→transportation path P8→transportation path P15”.

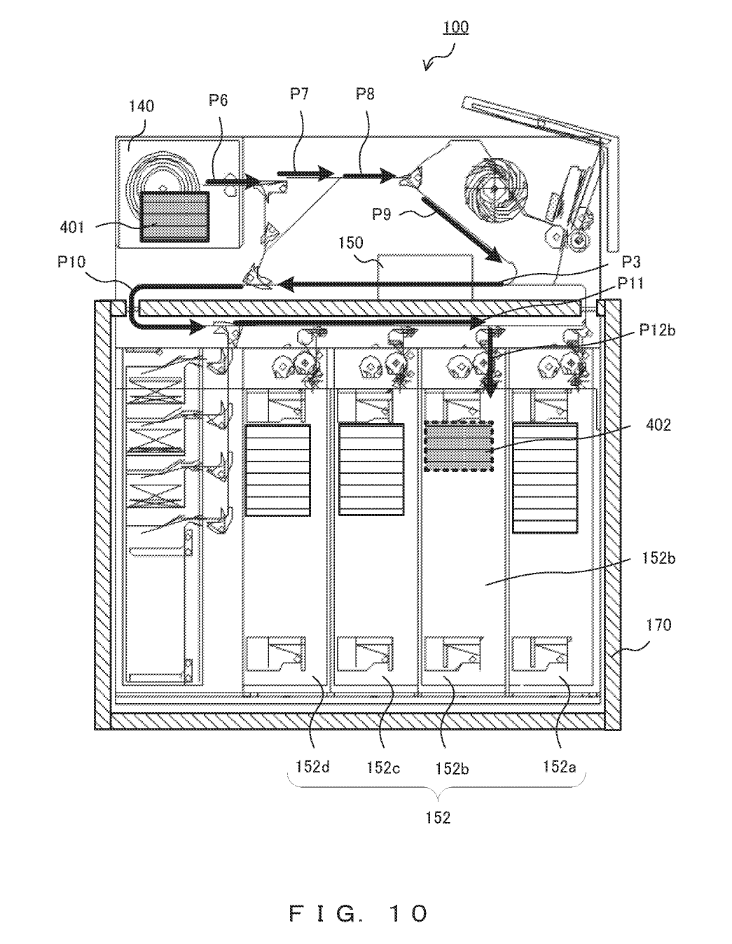

FIG. 10 is a diagram that illustrates a processing route for replenishing the storage unit 152 with bills from the temporary holder 140 in the ATM 100. If processing of replenishing the storage unit 152 with bills from the temporary holder 140 is performed, it is possible to replenish the storage unit 152 with bills without unlocking the door of the cashbox 170 when there is a shortage of bills of any one of the denominations in the storage unit 152. In this case, it is assumed that there is a shortage of bills in the bill cassette 152b.

First, a bank employee mounts an empty temporary holder 140 in, for example, the teller machine 200, and moves a predetermined number of bills from the teller machine 200 to the empty temporary holder 140. After the predetermined number of bills 401 are stored, the temporary holder 140 is removed from the teller machine 200. Then, the removed temporary holder 140 is mounted in the ATM 100.

After that, when receiving an instruction from the bank employee, the control unit 110a starts the replenishment processing. The bills 401 stored in the temporary holder 140 in advance are transported by the control unit 110a to a bill cassette for a corresponding denomination in the storage unit 152. Specifically, the bills move via “transportation path P6→transportation path P7→transportation path P8→transportation path P9→transportation path P3→transportation path P10→transportation path P11→transportation path P12b”, and the bill cassette 152b is replenished with the bills.

Accordingly, the bill cassette 152b in the storage unit 152 is replenished with a predetermined number of bills 402. The “predetermined number of bills” differs according to the size of the temporary holder 140, and is, for example, two hundred bills.

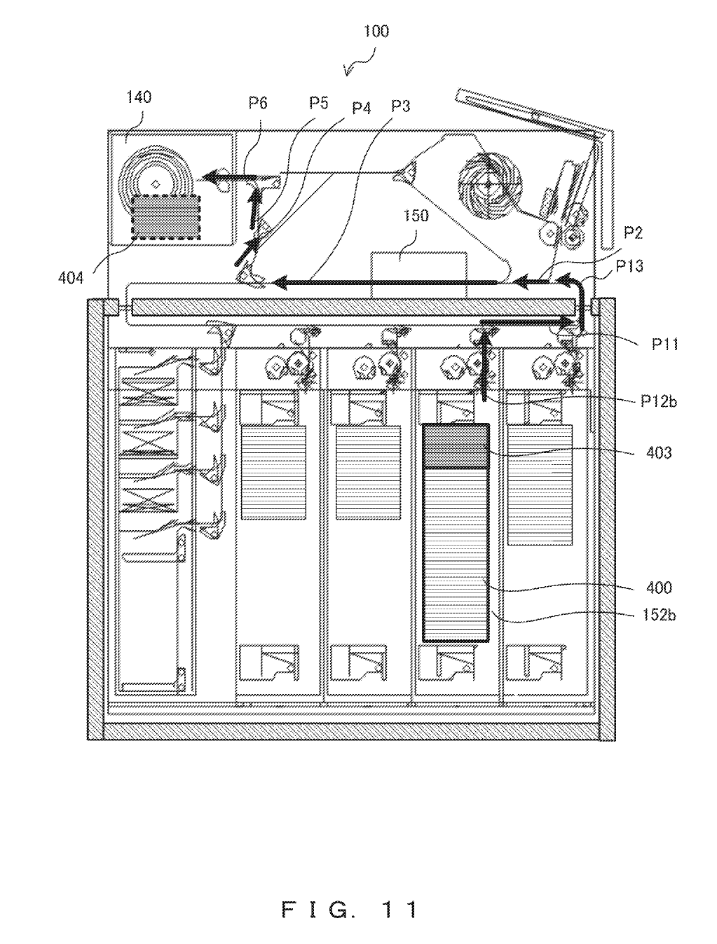

FIG. 11 is a diagram that illustrates a processing route for collecting bills into the temporary holder 140 from the storage unit 152 in the ATM 100. When a bill cassette for any one of the denominations in the storage unit 152 is full or nearly full of bills, processing of collecting a portion of the bills into the temporary holder 140 from the storage unit 152 is performed. Accordingly, it is possible to collect a portion of the bills from the storage unit 152 without unlocking the door of the cashbox 170.

In this case, it is assumed that the bill cassette 152b is full of bills and this is reported by a “full”-detection sensor to the control unit 110a. Bills 403 that are a portion of the bills 400 stored in the bill cassette 152b are transported by the control unit 110a to the temporary holder 140. Specifically, the bills 403 move via “transportation path P12b→transportation path P11→transportation path P13→transportation path P2→transportation path P3→transportation path P4→transportation path P5→transportation path P6”, and are stored in the temporary holder 140.

Accordingly, a predetermined number of bills 404 are collected into the temporary holder 140, and a space corresponding to the bills 403 is created in the bill cassette 152b in the storage unit 152. In this case, the “predetermined number of bills” differs according to the size of the temporary holder 140, and is, for example, two hundred bills. Further, when restarting the operation of the ATM 100 after the collection, the temporary holder 140 that contains the collected bills 404 may be replaced by a bank employee with an empty temporary holder 140, or the temporary holder 140 that contains the collected bills 404 may be mounted in the teller machine 200 so that the bills 404 are moved to the teller machine 200. Furthermore, the control unit 210a of the teller machine 200 may start the collection processing after an instruction is received from a bank employee.

[Bill Transportation Route in Teller Machine 200]

FIG. 12 is a diagram that illustrates the inside of the teller machine 200 and that explains a transportation route. In FIG. 12, the location in which a bank employee performs manipulation is on the right. The teller machine 200 is provided with the drop and discharge unit 232 on its upper right and the temporary holder 140 on the other side. As is the case with the ATM 100, the temporary holder 140 is fixed to the teller machine 200 with, for example, a screw, a locking lever, or a latch so as to be removable from the teller machine 200 as well. The temporary holder 140a represents an unmounted state. The determination unit 250 is provided in the center of the teller machine 200.

The teller machine 200 is provided with the storage unit 252 in its lower part. The storage unit 252 includes seven vertically long bill cassettes (252a, 252b, 252c, 252d, 252e, 252f, and 252g) for different denominations that are arranged in parallel from the right bills 400 are longitudinally loaded in each bill cassette in the storage unit 252. The teller machine 200 is provided with the reject unit 254 on its lower left. Four reject cassettes (254a, 254b, 254c, and 254d) are also arranged in the reject unit 254 in order from the top.

The teller machine 200 is provided with a cashbox 270 in its lower section. The storage unit 252 and the reject unit 254 are provided inside the cashbox 270. The cashbox 270 is locked by use of a door with a key (not shown) so as to protect the insides of the storage unit 252 and the reject unit 254. In other words, only a person who has a key of the cashbox 270 is able to directly supply the storage unit 252 with bills and to directly collect bills from the storage unit 252. On the other hand, the temporary holder 140 is arranged outside the cashbox 270, so it can be removed without the key of the cashbox 270. Further, the teller machine 200 is provided with casters 272 at the bottom.

The entirety of a transportation route will be described. Transportation path Q1 proceeding diagonally down and to the left and then transportation path Q2 proceeding to the left are provided so as to transport, to the inside, a bill dropped through the drop and discharge unit 232. Transportation path Q3 proceeding to the left passing through the determination unit 250 is provided and distally divided into two paths, and transportation path Q4 proceeding diagonally up and to the right and transportation path Q10 proceeding straight to the left are provided. Transportation path Q4 is distally divided into two paths, and transportation path Q5 proceeding straight up and transportation path Q14 proceeding diagonally up and to the right are provided.

Transportation path Q5 is distally divided into two paths, and transportation path Q6 proceeding to the right and left and transportation path Q7 proceeding to the right are provided. Proceeding to the left in transportation path Q6 leads into the temporary holder 140. Transportation path Q8 proceeding to the right is provided so as to be continuous from transportation path Q7. Transportation path Q8 is distally divided into two paths, and transportation path Q9 proceeding diagonally down and to the right and transportation path Q15 proceeding diagonally up and to the right are provided.

Transportation path Q10 proceeding to the left enters the cashbox 270 and is divided into two paths, and transportation path Q11 proceeding to the right and transportation path Q16 proceeding straight down are provided. Transportation path Q11 is provided to the right along the top of each bill cassette in the storage unit 252.

Transportation path Q12g that corresponds to the bill cassette 252g is provided so as to proceed downward midway in transportation path Q11. Likewise, transportation path Q12f that corresponds to the bill cassette 252f, transportation path Q12e that corresponds to the bill cassette 252e, transportation path Q12d that corresponds to the bill cassette 252d, transportation path Q12c that corresponds to the bill cassette 252c, transportation path Q12b that corresponds to the bill cassette 252b, and transportation path Q12a that corresponds to the bill cassette 252a are provided in different positions in transportation path Q11.

Transportation path Q13 proceeding straight up and then turns to the left is provided at the distal end of transportation path Q11. Transportation path Q13 proceeds out of the cashbox 270. The distal end of transportation path Q13 is connected to the back end of transportation path Q2.

The proceeding-down transportation path Q16 is provided along the left side of the four reject cassettes in the reject unit 254. Transportation path Q17a that corresponds to the reject cassette 254a is provided so as to proceed to the right midway in transportation path Q16. Likewise, transportation path Q17b that corresponds to the reject cassette 254b, transportation path Q17c that corresponds to the reject cassette 254c, and transportation path Q17d that corresponds to the reject cassette 254d are provided in different positions in transportation path Q16.

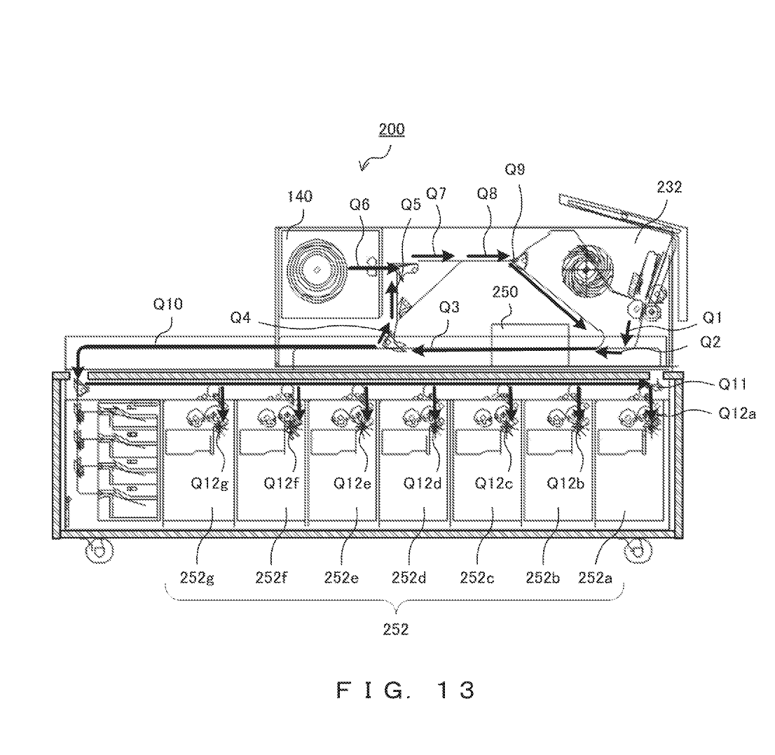

FIG. 13 is a diagram that illustrates a route on which a dropped bill is transported to the storage unit 252 via the temporary holder 140 in an ordinary transaction in the teller machine 200.

A bill dropped by a customer through the drop and discharge unit 232 enters the determination unit 250 via “transportation path Q1→transportation path Q2→transportation path Q3”. The bill allowed by the determination unit 250 as a determination result is stored in the temporary holder 140 via “transportation path Q3→transportation path Q4→transportation path Q5→transportation path Q6”.

The bill stored in the temporary holder 140 is transported from the temporary holder 140 via “transportation path Q6→transportation path Q7→transportation path Q8→transportation path Q9→transportation path Q3→transportation path Q10→transportation path Q11”, a transportation path (transportation path Q12a to transportation path Q12g) is selected according to a denomination, and the bill is stored in one of the bill cassettes (252a to 252g) in the storage unit 252.

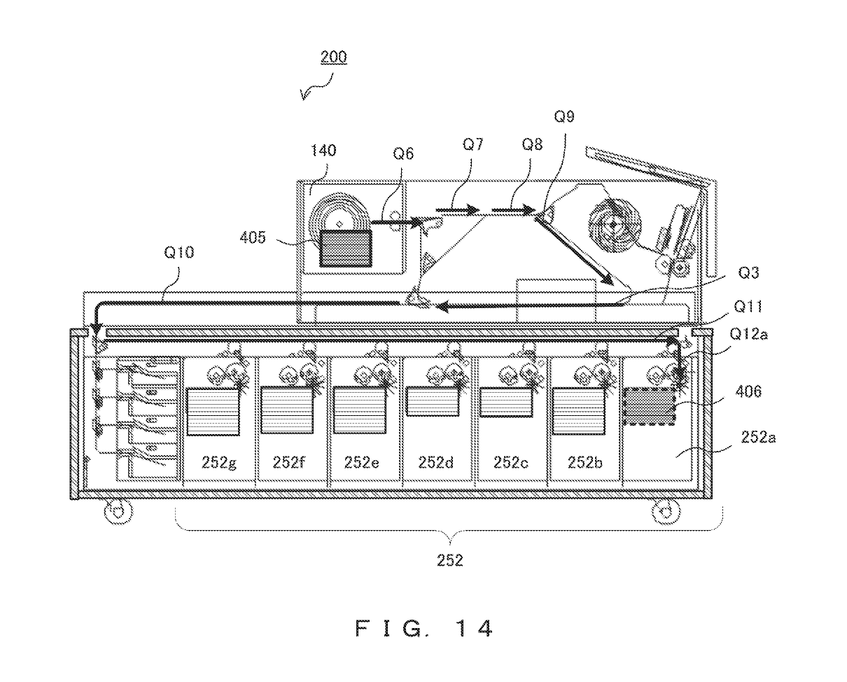

FIG. 14 is a diagram that illustrates a processing route for replenishing the storage unit 252 with bills from the temporary holder 140 in the teller machine 200. If processing of replenishing the storage unit 252 with bills from the temporary holder 140 is performed, it is possible to replenish the storage unit 252 with bills without unlocking the door of the cashbox 270 when there is a shortage of bills of any one of the denominations in the storage unit 252. The processing is equivalent to the replenishment processing in the ATM 100 that has been described in FIG. 10.

It is assumed that there is a shortage of bills of the denomination of the bill cassette 252a in the storage unit 252. A predetermined number of bills 405 stored in the temporary holder 140 in advance are transported by the control unit 210a to the bill cassette 252a in the storage unit 252. Specifically, the bills move via “transportation path Q6→transportation path Q7→transportation path Q8→transportation path Q9→transportation path Q3→transportation path Q10→transportation path Q11→transportation path Q12a”, and the bill cassette 252a in the storage unit 252 is replenished with the bills.

Accordingly, the bill cassette 252a in the storage unit 252 is replenished with a predetermined number of bills 406. The “predetermined number of bills” differs according to the size of the temporary holder 140, and is, for example, two hundred bills. Bills have to be stored in the temporary holder 140 in advance, but the description of this will be omitted because it is similar to that of FIG. 10. After an instruction is received from a bank employee, the control unit 210a starts the replenishment processing.

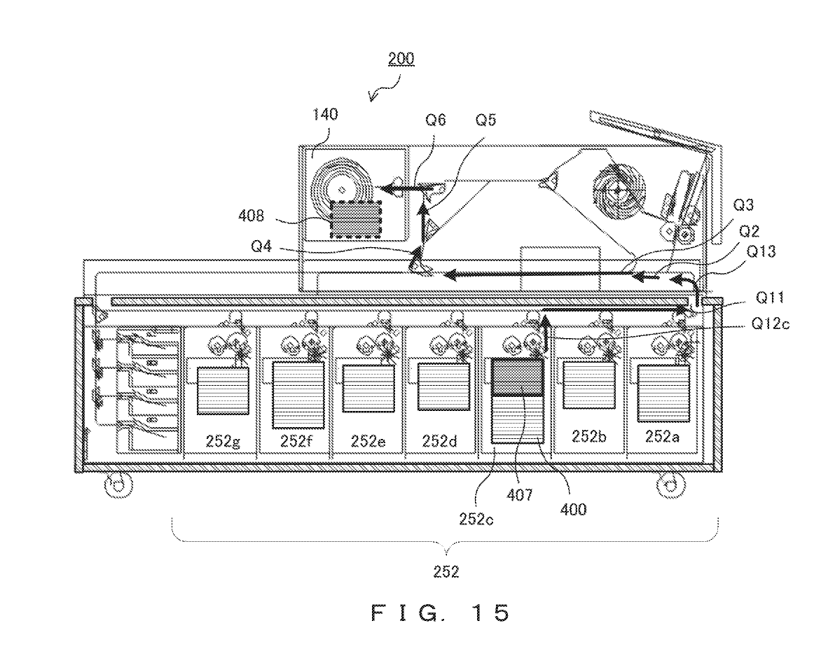

FIG. 15 is a diagram that illustrates a processing route for collecting bills into the temporary holder 140 from the storage unit 252 in the teller machine 200. When a bill cassette for anyone of the denominations in the storage unit 252 is full or nearly full of bills, processing of collecting a portion of the bills into the temporary holder 140 from the storage unit 252 is performed. Accordingly, it is possible to collect a portion of the bills 400 from the storage unit 252 without unlocking the door of the cashbox 170. The processing is equivalent to the collection processing in the ATM 100 that has been described in FIG. 11.

It is assumed that the bill cassette 252c is full of bills and this is reported by a “full”-detection sensor to the control unit 210a. Bills 407 that are a portion of the bills 400 stored in the bill cassette 252c in the storage unit 252 are transported by the control unit 210a to the temporary holder 140. Specifically, the bills 407 move via “transportation path Q12c→transportation path Q11→transportation path Q13→transportation path Q2→transportation path Q3→transportation path Q4→transportation path Q5→transportation path Q6”, and are stored in the temporary holder 140.

Accordingly, a predetermined number of bills 408 are collected into the temporary holder 140, and a space corresponding to the bills 407 is created in the bill cassette 252c in the storage unit 252. The “predetermined number of bills” differs according to the size of the temporary holder 140, and is, for example, two hundred bills.

Then, the temporary holder 140 has to be emptied after the collection, but the description will be omitted because it is similar to that of FIG. 11. Further, the control unit 210a may start the collection processing after an instruction is received from a bank employee.

[Processing of Bill Collection and Replenishment in Cash Transaction Device]

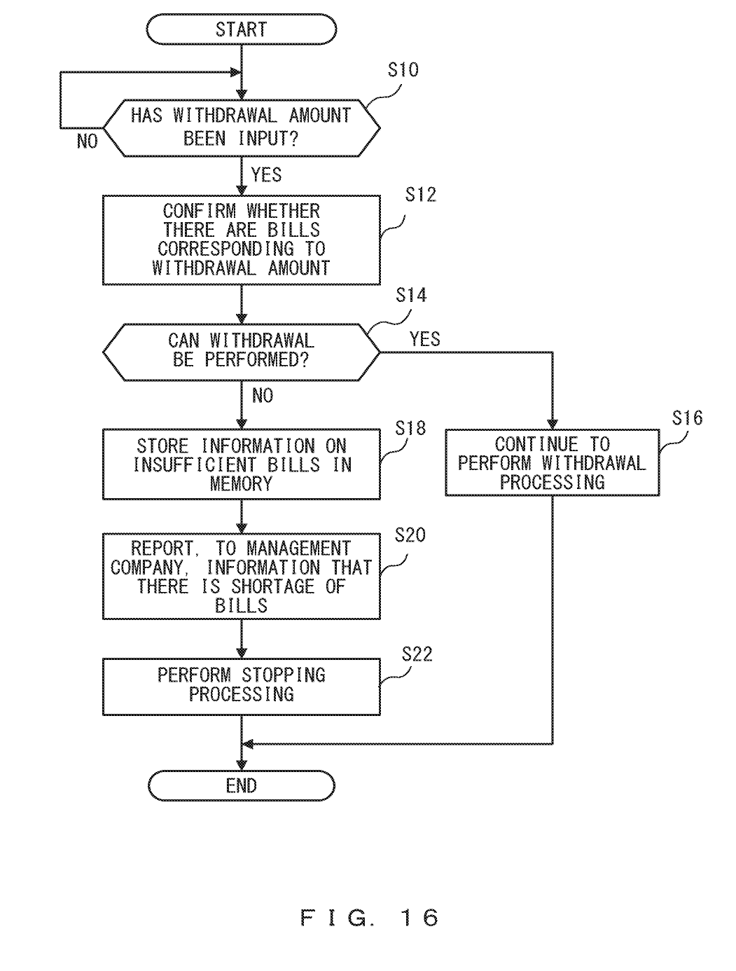

Comparing processing according to this embodiment to a conventional operation, a procedure of processing of bill collection and replenishment in a cash transaction device (the ATM 100 and the teller machine 200) will be described with reference to FIGS. 16 to 19.

As described above, substantially the same bill transaction processing is performed in the ATM 100 and the teller machine 200, so only the ATM 100 will be described in order to avoid a redundant description, but the same applies to the teller machine 200. The following processing is mainly performed by the control unit 110a in the ATM 100 and is mainly performed by the control unit 210a in the teller machine 200.

FIG. 16 is a flowchart that illustrates a procedure of processing of stopping a cash transaction device until a person in charge of a management company visits to replenish it with bills when there is a shortage of bills in the ATM 100. This is a conventional operation.

It is determined whether a withdrawal amount has been input (Step S10). The withdrawal amount is input by a customer into the ATM 100 and by a bank employee into the teller machine 200. The process of Step S10 is repeated until the withdrawal amount is input (NO in Step S10). When it is determined that the withdrawal amount has been input (YES in Step S10), it is confirmed whether there are bills corresponding to the withdrawal amount (Step S12). On the basis of data on the number of bills stored in the memory 112, it is confirmed whether there exist the corresponding bills in the storage unit 152.

Then, it is determined whether withdrawal can be performed (Step S14). When it is determined that the withdrawal can be performed because there exist the corresponding bills in the storage unit 152 (YES in Step S14), the withdrawal processing continues to be performed (Step S16).

When there do not exist the corresponding bills in the storage unit 152, it is determined that the withdrawal is not allowed to be performed (NO in Step S14), information on insufficient bills is stored in the memory 112 (Step S18), and information that there is a shortage of bills is reported to the management company 320 (Step S20). Then, processing of stopping the ATM 100 is performed (Step S22). As an example of the stopping processing, a message such as “Out of Service” is displayed on the display panel 116, and the ATM 100 is caused to enter a mode in which manipulation performed by a customer is not accepted. After that, a person in charge is sent to the branch of a bank by the management company that received the report, and a transaction by use of the ATM 100 can be restarted after the storage unit 152 is replenished with bills.

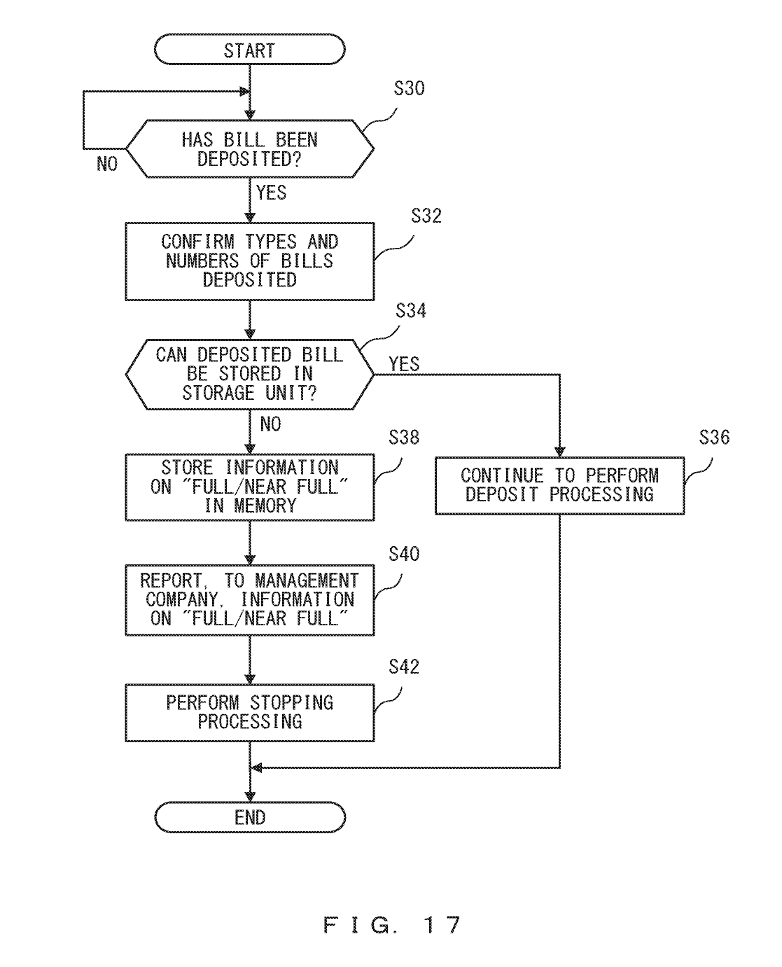

FIG. 17 is a flowchart that illustrates processing of stopping a cash transaction device until a person in charge of a management company visits to collect bills when the ATM 100 is full of bills. This is a conventional operation.

It is determined whether a bill has been deposited by a customer (Step S30). It is determined, by use of an output of a sensor provided in the drop and discharge unit 132, whether a bill has been deposited. The process of Step S30 is repeated until it is determined that a bill has been deposited (NO in Step S30). When it is determined that a bill has been deposited (YES in Step S30), the types and the number of bills deposited are confirmed (Step S32). The types and the number of bills deposited are confirmed in the determination unit 150.

It is determined whether the deposited bill can be stored in the storage unit 152 (Step S34). On the basis of current data on the number of bills that are stored in each bill cassette, the data being stored in the memory 112, and on the basis of a “full”- or “nearly full”-detection sensor provided in the bill cassette, it is determined whether the deposited bill can be stored.

When it is determined that the deposited bill can be stored in the storage unit 152 (YES in Step S34), the deposit processing continues to be performed (Step S36), and the deposited bill is stored in a corresponding bill cassette in the storage unit 152.

When it is determined that the deposited bill is not allowed to be stored in the storage unit 152 (NO in Step S34), that is, when it is determined that the corresponding bill cassette in the storage unit 152 is full of bills, information on “full/nearly full” is stored in the memory 112 (Step S38), and the information on “full/nearly full” is reported to the management company 320 (Step S40). Then, processing of stopping the ATM 100 is performed (Step S42). The stopping processing is similar to that of Step S22 of FIG. 16, so the description will be omitted. After that, a person in charge is sent to the branch of a bank by the management company that received the report, and a transaction by use of the ATM 100 can be restarted after bills are collected from the storage unit 152.

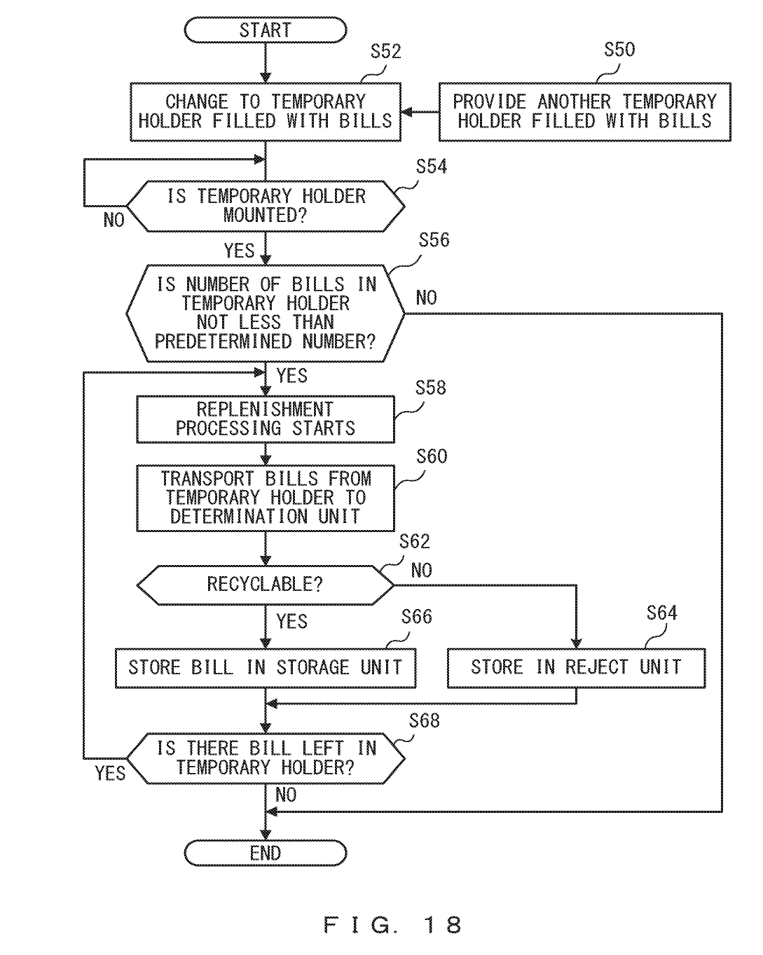

FIG. 18 is a flowchart that illustrates a procedure of processing of replenishing the storage unit 152 with bills from the temporary holder 140 when there is a shortage of bills in the ATM 100. Using the processing illustrated in FIGS. 10 and 14, it is possible to replenish the storage unit 152 with bills without unlocking the door of the cashbox 170.

Another temporary holder filled with bills is provided (Step S50). When it is detected that there is a shortage of bills in the storage unit 152, it is a bank employee who provides another temporary holder filled with bills. Replenishment processing is as described in FIG. 10.

Then, the bank employee changes the temporary holder 140 to the temporary holder filled with bills (Step S52). It is determined whether the temporary holder 140 is mounted in the ATM 100 (Step S54). By whether the CPU 110 can communicate normally with the temporary holder 140, it is determined whether the temporary holder 140 is mounted in the ATM 100. When it is determined that the temporary holder 140 is not mounted normally in the ATM 100 (NO in Step S54), the process of Step S54 is repeated until the temporary holder 140 is mounted normally in the ATM 100 by displaying, for example, a warning.

When it is determined that the temporary holder 140 is mounted in the ATM 100 (YES in Step S54), it is determined whether the number of bills in the temporary holder 140 is not less than a predetermined number (Step S56). On the basis of the data on the number of bills that is stored in the holder memory 146, it is determined whether the number of bills is not less than the predetermined number. When it is determined that the number of bills in the temporary holder 140 is less than the predetermined number (NO in Step S56), the replenishment processing stops and ends.

When it is determined that the number of bills in the temporary holder 140 is not less than the predetermined number (YES in Step S56), the replenishment processing starts (Step S58). Bills are transported from the temporary holder 140 to the determination unit 150 (Step S60). It is determined, on the basis of a result of determination performed by the determination unit 150, whether the transported bills are recyclable (Step S62). When it is determined that a transported bill is not recyclable (NO in Step S62), the bill determined to be non-recyclable is stored in the reject unit 154 (Step S64).

When it is determined that a bill is recyclable (YES in Step S62), the bill is stored in a corresponding bill cassette in the storage unit 152 (Step S66). After Step S64 and Step S66, it is determined whether there is a bill left in the temporary holder 140 (Step S68). When it is determined that there is a bill left in the temporary holder 140 (YES in Step S68), the process returns to Step S58, and transportation of a next bill from the temporary holder 140 is repeated. When it is determined that there is no longer a bill left in the temporary holder 140 (NO in Step S68), the transportation of the bills with which the temporary holder 140 is filled to the storage unit 152 is completed, and this processing ends.

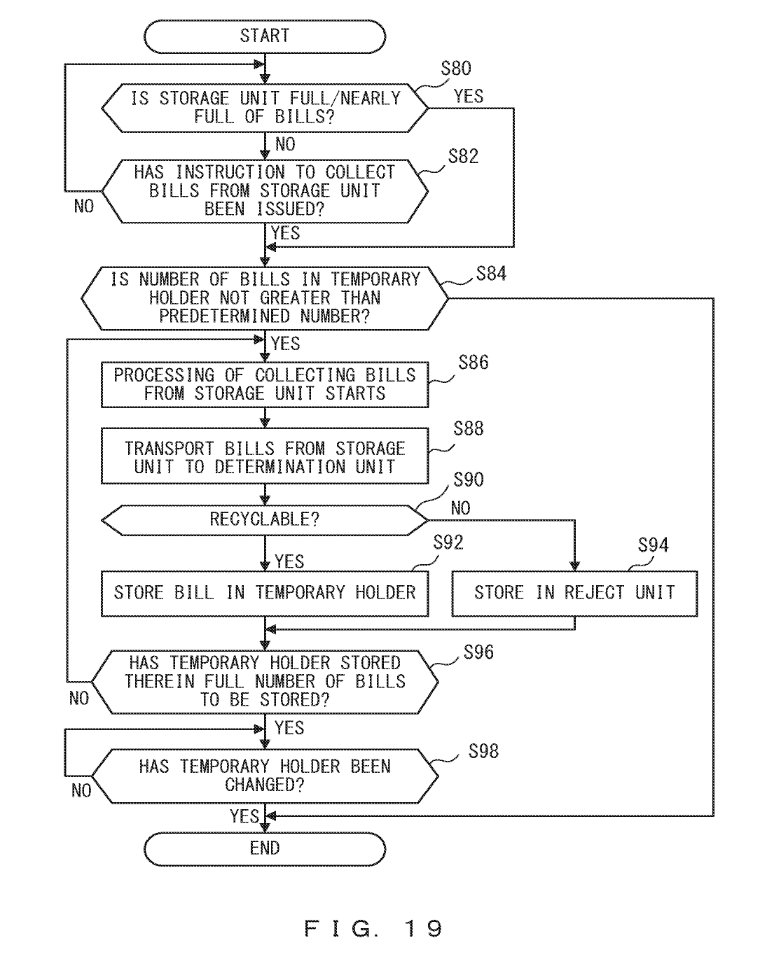

FIG. 19 is a flowchart that illustrates a procedure of processing of collecting bills from the storage unit 152 to the temporary holder 140 when the ATM 100 is full or nearly full of bills. Using the processing illustrated in FIGS. 11 and 15, it is possible to collect bills from the storage unit 152 without unlocking the door of the cashbox 170.

It is determined whether the storage unit 152 is full or nearly full of bills (Step S80). It is determined, by use of an output of a “full”-detection sensor or a “nearly full”-detection sensor, whether a bill cassette corresponding to any one of the denominations in the storage unit 152 is full or nearly full of bills.

When it is determined that the storage unit 152 is not full or nearly full of bills (NO in Step S80), it is determined whether an instruction to collect bills from the storage unit 152 has been issued (Step S82). In this example, the collection processing starts when a “full” state or a “nearly full” state is detected with respect to any one of the denominations, and even if the “full” state or the “nearly full” state is not detected, the collection processing is also performed when the instruction is issued by a bank employee.

When it is determined that the instruction to collect bills from the storage unit 152 has not been issued (NO in Step S82), the process returns to Step S80. When it is determined that the instruction to collect bills from the storage unit 152 has been issued (YES in Step S82), or when it is determined that the storage unit 152 is full or nearly full of bills (YES in Step S80), the process moves on to Step S84.

It is determined whether the number of bills in the temporary holder 140 is not greater than a predetermined number (Step S84). Normally, the number of bills in the temporary holder 140 is zero. The reason is that, if there are many bills left in the temporary holder 140, a problem will occur when the collection from the storage unit 152 is performed. When it is determined that the number of bills in the temporary holder 140 is greater than the predetermined number (NO in Step S84), the replenishment processing is aborted and exited.

When it is determined that the number of bills in the temporary holder 140 is not greater than the predetermined number (YES in Step S84), the processing of collecting bills from the storage unit 152 starts (Step S86). The bill cassette from which bills are collected is a bill cassette in which a “full” state or a “nearly full” state is detected, or a bill cassette designated by an instruction as a target to be collected in Step S82.

Bills are transported from the storage unit 152 to the determination unit 150 (Step S88). It is determined, on the basis of a result of determination performed by the determination unit 150, whether the transported bills are recyclable (Step S90). When it is determined that a transported bill is not recyclable (NO in Step S90), the bill determined to be non-recyclable is stored in the reject unit 154 (Step S94).

When it is determined that a bill is recyclable (YES in Step S90), the bill is stored in the temporary holder 140 (Step S92). After Step S92 and Step S94, it is determined whether the temporary holder 140 has stored therein the full number of bills to be stored (Step S96). When it is determined that the temporary holder 140 has not stored therein the full number of bills to be stored (NO in Step S96), the process returns to Step S86, and transportation of a next bill from the storage unit 152 to the temporary holder 140 is repeated.

When it is determined that the temporary holder 140 has stored therein the full number of bills to be stored or the number of the collected bills is not less than the predetermined number (YES in Step S96), the processing of collecting bills from the storage unit 152 ends. At the same time, the types and the number of the stored bills are recorded in the holder memory 146.

Next, it is determined whether the temporary holder 140 has been changed to an empty temporary holder (Step S98). The reason is that it is not possible to use the ATM 100 for a normal transaction if the temporary holder 140 has stored therein the collected bills. The process of Step S98 is repeated until the temporary holder 140 is changed to an empty temporary holder (NO in Step S98). When it is determined that the temporary holder 140 has been changed to an empty temporary holder (YES in Step S98), the collection is completed, and the collection processing ends.

At least the following advantages are provided by the embodiment described above.
A person in charge of a management company visits a branch of a bank regularly to perform cash (bills and coins) replenishment/collection with respect to a cash transaction device. In addition, a report is automatically sent from the cash transaction device to the management company in collaboration with the bank when, for example, there is a shortage of cash inside the cash transaction device, so the person in charge of the management company visits the branch for, for example, cash replenishment accordingly. However, at a branch of a bank that outsources cash management to a management company, it becomes impossible to use a cash transaction device from the arrival of the person in charge from the management company until the completion of, for example, replenishment work because a bank employee is not allowed, for example, to replenish the device with bills. Long-lasting downtime of a cash transaction device is a critical problem for financial institutions.

Embodiments of the present invention provide a paper sheet (cash) transaction device in which paper sheet (bill) collection or replenishment can be performed without a cashbox of the paper sheet transaction device being unlocked.
If replenishment with paper sheets (bills) from a temporary holder is performed when there is a shortage of paper sheets (bills) in a paper sheet (bill) transaction device, or if collection of paper sheets (bills) into the temporary holder 140 is performed when the paper sheet (bill) transaction device is full of paper sheets (bills), even in a branch of a bank in which a bank employee is not allowed to open or close a cashbox, it is possible to substantially continually operate the paper sheet (cash) transaction device provisionally until a person in charge of a management company arrives. Further, the downtime of the paper sheet (cash) transaction device is shorter because replenishment or collection processing is performed by use of a temporary holder.
If a temporary holder is used for bill replenishment or collection, a dedicated replenishment/collection device does not have to be provided, which results in preventing an increase in the size of a cash transaction device and an increase in cost.
A temporary holder 140 is configured to be removable from a cash transaction device, so it is possible to operate a cash transaction device whose temporary holder 140 can be changed to another temporary holder 140 that is provided in advance. Accordingly, it is possible to make the downtime of the cash transaction device shorter. Further, there is a compatibility between the temporary holder of the ATM 100 and the temporary holder of the teller machine 200, so it is possible to easily replenish with bills or collect bills between the ATM 100 and the teller machine 200.

The following is a modification of the present embodiment.
In the above description, the ATM 100 and the teller machine 200 are each provided with a removable temporary holder 140, but only one of them may be provided with the removable temporary holder 140. It is possible to perform replenishment processing or collection processing even when only one of the ATM 100 and the teller machine 200 is provided with the removable temporary holder.
Further, only one of the replenishment processing and the collection processing may be provided.
In the above description, the ATM 100 and the teller machine 200 include the same temporary holder, but it is sufficient if there is a compatibility of the connection, and there may be a difference in appearance or function between the temporary holder of the ATM 100 and the temporary holder of the teller machine 200.
It is acceptable if the temporary holder is not provided with a holder memory. The control unit 110a may determine, by use of the sensor 141, whether there exists a bill.
Further, the temporary holder 140 maybe provided with a cover that can be opened and closed, so that bills stored inside can be taken out or bills can be stored inside. This makes the bill collection/replenishment processing more convenient.

In addition, the present invention is not limited to the above-described embodiments as they are, but may be embodied by deforming constituents within a scope not deviating from the gist of the invention at an execution step. In addition, various inventions can be made by appropriately combining a plurality of constituents that have been disclosed in the above embodiments. For example, all the constituents that have been disclosed in the embodiments may be appropriately combined. Further, constituents in different embodiments may be appropriately combined. It should be understood that various modifications and applications can be made without departing from the scope and the spirit of the invention.

### EXPLANATION OF LETTERS OR NUMERALS

100 ATM
110, 210 CPU
110a, 201a control unit
112, 211 memory
114, 214 communication I/F
116, 216 display panel
118, 218 card unit
120, 220 bankbook unit
122, 222 coin unit
130, 230 bill unit
132, 232 drop and discharge unit
140 temporary holder
141 sensor
143 bill-take-up roller
144 film
145 driving circuit
146 holder memory
150, 250 determination unit
152, 252 storage unit
154, 254 reject unit
160, 260 transporter
162 roller
163 sensor
170, 270 cashbox
200 teller machine
300 network
310 host computer
320 management company
400 bill

What is claimed is:

1. A paper sheet transaction device used for a paper sheet transaction performed by a user, the device comprising:
a drop unit through which a paper sheet is dropped;
a storage unit that stores therein a paper sheet dropped through the drop unit;
a temporary holder that temporarily stores therein a predetermined number of paper sheets; and
a control unit that controls transportation of the paper sheets between the drop unit and the storage unit according to a content of processing, wherein
the temporary holder is removably provided in the paper sheet transaction device, and
the control unit performs a control such that the temporary holder is a space that temporarily holds a paper sheet dropped through the drop unit before the paper sheet is stored in the storage unit when processing of a paper sheet transaction performed by the user is performed, performs a control such that the temporary holder is a space into which at least a portion of the paper sheets in the storage unit are collected when processing of collecting the paper sheets from the storage unit is performed, and performs a control such that the paper sheets stored in advance in the temporary holder are transported to the storage unit when processing of replenishing the storage unit with the paper sheets is performed.

2. The paper sheet transaction device according to claim 1, comprising a lockable cashbox that stores therein the storage unit, wherein
the temporary holder is arranged outside the cashbox.

3. The paper sheet transaction device according to claim 1, wherein
the storage unit is divided into a plurality of cassettes,
each of the plurality of cassettes is provided with a detector that detects a state in which the cassette is full or nearly full of the paper sheets, and
the control unit performs processing of collecting the paper sheets according to the detection performed by the detector.

4. The paper sheet transaction device according to claim 1, wherein the paper sheet transaction device collects a predetermined number of paper sheets from the storage unit when processing of collecting the paper sheets is performed.

5. The paper sheet transaction device according to claim 1, wherein the paper sheet transaction device is at least one of an automatic teller machine primarily used for a transaction with a customer and a teller machine primarily handled by a bank employee.

6. The paper sheet transaction device according to claim 1, wherein
the temporary holder is removably provided in the paper sheet transaction device, and
the paper sheet transaction device is applied to both the automatic teller machine primarily used for a transaction with a customer and the teller machine primarily handled by a bank employee, and there is a compatibility between the temporary holder removably provided in the automatic teller machine and the temporary holder removably provided in the teller machine.

7. A method for operating the paper sheet transaction device according to claim 6, the method comprising:
when a storage unit is full or nearly full of paper sheets in either one of the paper sheet transaction devices, that is, the automatic teller machine or the teller machine, determining that the paper sheet transaction device full or nearly full of paper sheets is a paper sheet transaction device full of paper sheets, performing processing of collecting the paper sheets from the paper sheet transaction device full of paper sheets, removing the temporary holder having stored therein the collected paper sheets, and mounting the temporary holder in the paper sheet transaction device that is not full of paper sheets, so as to perform processing of moving the paper sheets stored in the temporary holder to the paper sheet transaction device that is not full of paper sheets; and
when there is a shortage of paper sheets in either one of the paper sheet transaction devices, that is, the automatic teller machine or the teller machine, performing processing of collecting the paper sheets from the paper sheet transaction device in which there is no shortage of paper sheets, removing the temporary holder having stored therein the collected paper sheets, and mounting the temporary holder in the paper sheet transaction device in which there is a shortage of paper sheets, so as to perform processing of replenishing the storage unit of the paper sheet transaction device in which there is a shortage of paper sheets with the paper sheets stored in the temporary holder.

8. A temporary holding device that is provided in a paper sheet transaction device used for a paper sheet transaction performed by a user and that temporality holds a paper sheet deposited by the user into the paper sheet transaction device before the deposited paper sheet is stored in a storage unit, wherein
the paper sheet transaction device is provided with a cashbox that protects therein the storage unit, and the temporary holding device is arranged outside the cashbox and is removably provided with respect to the paper sheet transaction device, and
the temporary holding device stores therein paper sheets that are transported and collected from the storage unit when the storage unit is full or nearly full of the paper sheets, and stores therein paper sheets with which the storage unit is replenished when there is a shortage of paper sheets in the storage unit.
